(19) United States
(12) Patent Application Publication
(10) Pub. No.: US 2016/0162440 A1
(43) Pub. Date: Jun. 9, 2016

(54) RETRIEVAL APPARATUS, RETRIEVAL METHOD, AND COMPUTER PROGRAM PRODUCT

(71) Applicant: Kabushiki Kaisha Toshiba, Tokyo (JP)

(72) Inventors: Toshiaki NAKASU, Shinagawa Tokyo (JP); Yuto YAMAJI, Kawasaki Kanagawa (JP); Tomoyuki SHIBATA, Kawasaki Kanagawa (JP); Osamu YAMAGUCHI, Yokohama Kanagawa (JP)

(21) Appl. No.: 14/938,648

(22) Filed: Nov. 11, 2015

(30) Foreign Application Priority Data
Dec. 5, 2014 (JP) 2014-247287

(51) Int. Cl. G06F 17/21

(52) U.S. Cl. CPC G06F 17/211

(57) ABSTRACT

According to an embodiment, a retrieval apparatus includes a receiver, a retrieval controller, a generating controller, and a display controller. The receiver receives designation of first element information that is at least one of a type, a position, a size, a shape, and a color of one or more first components, and receives symbol data that symbolizes the one or more first components. The retrieval controller retrieves content based on the symbol data. The generating controller generates a symbol image that symbolizes the one or more second components, based on second element information that is at least one of a type, a position, a size, a shape, and a color in the content. The display controller displays the symbol image on a display.

### CROSS-REFERENCE TO RELATED APPLICATIONS

This application is based upon and claims the benefit of priority from Japanese Patent Application No. 2014-247287, filed on Dec. 5, 2014; the entire contents of which are incorporated herein by reference.

### FIELD

Embodiments described herein relate generally to a retrieval apparatus, a retrieval method, and a computer program product.

### BACKGROUND

Techniques to retrieve documents using queries input by users in handwriting are conventionally known.

However, in the conventional techniques described above, retrieval results also contain information other than information that has been used by users for retrieval, and users have difficulty in understanding the correspondence between the information that has been used for retrieval and the retrieval results.

### BRIEF DESCRIPTION OF THE DRAWINGS

FIG. 1 is a configuration diagram illustrating an example of a retrieval apparatus of the present embodiment;

FIG. 2 is a diagram illustrating an example of content to be retrieved in the present embodiment;

FIG. 3 is a diagram illustrating an example of handwritten symbol data in the present embodiment;

FIG. 4 is a diagram illustrating an example of retrieval results in the present embodiment;

FIG. 5 is a diagram illustrating an example of the content to be retrieved in the present embodiment;

FIG. 6 is a diagram illustrating an example of handwritten symbol data in the present embodiment;

FIG. 7 is a diagram illustrating an example of the handwritten symbol data in the present embodiment;

FIG. 8 is a diagram illustrating an example of the handwritten symbol data in the present embodiment;

FIG. 9 is a diagram illustrating an example of the handwritten symbol data in the present embodiment;

FIG. 10 is a diagram illustrating an example of the handwritten symbol data in the present embodiment;

FIG. 11 is a diagram illustrating an example of a display screen of the present embodiment;

FIG. 12 is a diagram illustrating an example of the display screen of the present embodiment;

FIG. 13 is a diagram illustrating an example of the display screen of the present embodiment;

FIG. 14 is a diagram illustrating an example of the display screen of the present embodiment;

FIG. 15 is a diagram illustrating an example of the display screen of the present embodiment;

FIG. 16 is a flowchart illustrating a processing example of the present embodiment;

FIG. 17 is a diagram illustrating an example of content to be retrieved in a third modification;

FIG. 18 is a diagram illustrating an example of symbol data in the third modification; and

FIG. 19 is a diagram illustrating a hardware configuration example of the retrieval apparatus of the embodiment and the modifications.

### DETAILED DESCRIPTION

According to an embodiment, a retrieval apparatus includes a receiver, a retrieval controller, a generating controller, and a display controller. The receiver receives designation of first element information that is at least one of a type, a position, a size, a shape, and a color of one or more first components, and receives symbol data that symbolizes the one or more first components. The retrieval controller retrieves content based on the symbol data. The generating controller generates a symbol image that symbolizes the one or more second components in the content, based on second element information that is at least one of a type, a position, a size, a shape, and a color in the content. The display controller displays the symbol image on a display.

Embodiments will be described below in detail with reference to the accompanying drawings.

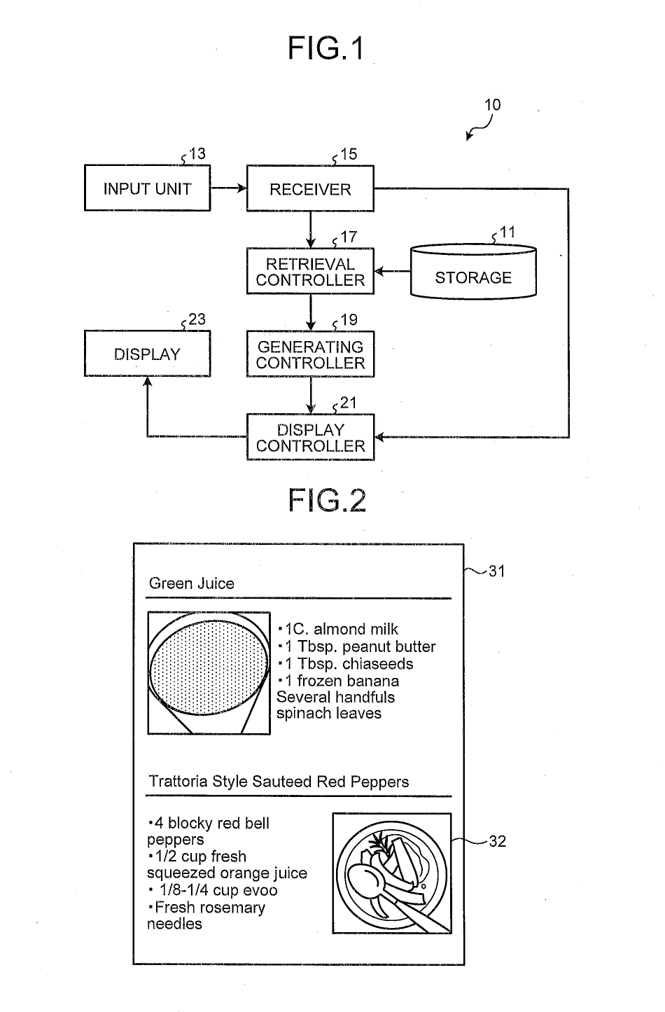

FIG. 1 is a configuration diagram illustrating an example of a retrieval apparatus 10 of the present embodiment. As illustrated in FIG. 1, the retrieval apparatus 10 includes a storage 11, an input unit 13, a receiver 15, a retrieval controller 17, a generating controller 19, a display controller 21, and a display 23.

The retrieval apparatus 10 can be implemented by, for example, a tablet terminal, a smartphone, or a personal computer (PC), each being capable of input using a digital pen.

The storage 11 can be implemented by, for example, a storage apparatus capable of magnetic, optical, or electric storage such as a hard disk drive (HDD), a solid state drive (SSD), a memory card, an optical disc, a random access memory (RAM), and a read only memory (ROM).

The input unit 13 can be implemented by, for example, an input apparatus capable of handwriting input, such as a digital pen and touch panel display. The receiver 15, the retrieval controller 17, the generating controller 19, and the display controller 21 may be implemented by, for example, causing a processing apparatus such as a central processing unit (CPU) to execute a computer program, that is, by software, implemented with hardware such as an integrated circuit (IC), or implemented by using software in combination with hardware. The display 23 can be implemented by, for example, a display device such as a touch panel display.

The storage 11 stores therein a plurality of records each of which associates content with element information that is at least one of a type, a position, a size, a shape, and a color of one or more components in the content with each other.

In the present embodiment, the content is assumed to include digital documents such as documents prepared by document preparation software, spreadsheet software, presentation software, document browsing software, or the like and web pages and handwritten documents prepared by inputting handwritten data by users, but the content is not limited thereto. The content may also include still images and moving images.

In the following, one or more components designated by a user through the input unit 13 will be referred to as one or more first components. In addition, the element information that is at least one of a type, a position, a size, a shape, and a color of the one or more first components, will be referred to as first element information.

Similarly, one or more components in the content will be referred to as one or more second components. In addition, element information that is at least one of a type, a position, a size, a shape, and a color of the one or more second components, will be referred to as second element information. The second element information may further represent a relative position relation between the one or more second components.

The second component is an area that the user can recognize on the content. Examples of the position of the second component include coordinates information on a page. The relative position relation between the second components can be determined from the positions (coordinates information) of the second components.

The type of the second component can be at least one of, for example, a text, a figure, a table, an image, a picture, a numerical formula, a map, a memorandum (an annotation) added by the user, and other items. When the type of the second component is the text, the type may further be fractionalized into a paragraph, a line, a word, one letter, a radical, or other elements. When the type of the second component is the figure or the table, category may further be fractionalized into a straight line, a triangle, a rectangle, a circle, or other shapes.

When the type of the second component is the image, the type may further be factionalized into an object within an image, an edge, or other elements. To recognize the object within the image, an object recognition process may be used that is disclosed in, for example, Jim Mutch and David G. Lowe, “Multiclass Object Recognition with Sparse, Localized Features”, IEEE Conference on Computer Vision and Pattern Recognition (CVPR), pp. 11-18, New York, June 2006. The edge is a line on which a brightness value or a color sharply changes within the image. The type of the second component may be, for example, a color such as red, blue, and green. In addition, the type of the second component may be density, for example, represented as dense or sparse.

When the content is a digital document, the content contains, as document information, information that can determine the type, the position, the size, the shape, and the color of the second components and the relative position relation between the second components. When the content is the digital document, therefore, analyzing the content can generate the second element information.

Also when the content is a handwritten document, analyzing a class to which each stroke constituting handwritten data belongs and a position of each stroke can determine the type, the position, the size, the shape, and the color of the second components and the relative position relation between the second components. The class is, for example, at least one of a text, a figure, a table, an image, a picture, a numerical formula, a map, and a memorandum added by the user. Also when the content is handwritten data, therefore, analyzing the content can generate the second element information.

The class to which the stroke belongs may be determined by a method of structuring a group of strokes with a spatial or a temporal cluster and determining, in structure units thus structured, a class to which the stroke belonging to the structure belongs. Alternatively, the class to which the stroke belongs may be determined by a method of extracting, for each stroke, one or more surrounding strokes present around the stroke, calculating a combination characteristic amount related to a characteristic of a combination of the stroke and the extracted one or more surrounding strokes, and determining a class to which the stroke belongs by the calculated combination characteristic amount.

The combination characteristic amount includes a first characteristic amount indicating a relation between a subject stroke and at least one of the one or more surrounding strokes. In addition, the combination characteristic amount includes a second characteristic amount using a sum value, which is the sum of a characteristic amount related to a shape of the subject stroke and characteristic amounts related to respective shapes of the one or more surrounding strokes.

The first characteristic amount is at least one of similarity in shape between the subject stroke and at least one of the one or more surrounding strokes and a determining value determining a position relation between the subject stroke and at least one of the one or more surrounding strokes.

The similarity in shape is, for example, similarity in at least one of a length, the sum of curvatures, a main component direction, the area of a circumscribed rectangle, the length of the circumscribed rectangle, the aspect ratio of the circumscribed rectangle, the distance between a starting point and an ending point, a direction density histogram, and the number of bending points between the subject stroke and at least one of the one or more surrounding strokes. In other words, the similarity in shape is, for example, similarity between a stroke characteristic amount of the subject stroke and a stroke characteristic amount of at least one of the one or more surrounding strokes.

The determining value is, for example, at least one of the overlapping rate of circumscribed rectangles, the distance between the centers of gravity, the direction of the distance between the centers of gravity, the distance between end points, the direction of the distance between end points, and the number of intersections between the subject stroke and at least one of the one or more surrounding strokes.

The second characteristic point is, for example, at least one of: the ratio of the sum of the length of the subject stroke and the lengths of the respective one or more surrounding strokes to the length of a combined circumscribed rectangle; the sum value of the direction density histograms of the subject stroke and the one or more surrounding strokes; and the ratio of the sum of the area of the circumscribed rectangle of the subject stroke and the areas of the respective circumscribed rectangle of the one or more surrounding strokes to the area of the combined circumscribed rectangle.

The input unit 13 designates the first element information, which is at least one of the type, the position, the size, the shape, and the color of the one or more first components, and inputs symbol data that symbolizes the one or more first components. In the symbol data, by designating respective positions of the one or more components, a relative position relation between the one or more first components is also designated.

Although, in the present embodiment, the one or more first components are on the same page and the respective positions of the one or more first components are positions on the same page, the positions of the one or more first components are not limited thereto.

In the present embodiment, the input unit 13 is a digital pen and a touch panel display. The user designates the first element information on the touch panel display with an icon or other items using the digital pen or a finger, or designates the first element information by handwriting, whereby the input unit 13 inputs the symbol data. However, the input unit 13 is not limited thereto, but may be implemented by, for example, a touch pad or a mouse.

The stroke is data indicating one stroke of the first element information handwritten by the user, that is, a trajectory of the digital or the finger from a touch on an input surface of the touch panel display until away from the input surface (from pen down until pen up) and can be represented as, for example, time-series coordinate values of a contact point between the digital pen or the finger and the input surface.

The receiver 15 receives input of the symbol data from the input unit 13.

The retrieval controller 17 retrieves content based on the symbol data received by the receiver 15. Specifically, the retrieval controller 17 retrieves, based on the symbol data received by the receiver 15, a record containing the second element information similar to the first element information from the storage 11.

The retrieval controller 17, for example, quantizes the positions, the sizes, the shapes, and the colors of the respective one or more first components that the first element information represents. The retrieval controller 17 acquires a record from the storage 11 and quantizes the positions, the sizes, the shapes, and the colors of the respective one or more second components that the second element information contained in the record represents.

Next, the retrieval controller 17 compares, for each of the one or more first components, quantized values of the position, the size, the shape, and the color of the first component with quantized values of the position, the size, the shape, and the color of each of the one or more second components. If the ratio of matching quantized values is a certain ratio or more, and if the type of the first component and the type of the second component match, the retrieval controller 17 determines the second component to be similar to the first component. Furthermore, the retrieval controller 17 sets, as similarity, the ratio of the second components matching the one or more first components. If the similarity is a threshold or more, the second element information is similar to the first element information.

For example, the retrieval controller 17 may determine the similarity between the first component and the second component by determining whether or not a difference between the first component and the second component is within the range of a differential characteristic defined in advance. In this case, as the differential characteristic of the category, a semantic close relation between categories may be used; as the differential characteristic of the position, a distance obtained by normalizing a distance between coordinates with an image size may be used; as the differential characteristic of the size, an aspect ratio may be used; as the differential characteristic of the shape, correlation of edge information of circumscribed shapes is may be used; and as the differential characteristic of the color, a color histogram nay be used.

For example, the retrieval controller 17 may determine the similarity between the first component and the second component using a discriminator. In this case, a discriminator may be used that is trained by a general mechanical learning process such as support vector machine (SVM) as a 2-class problem using differential characteristics with component pairs determined to subjectively match and component pairs determined not to subjectively match as statistical data.

The retrieval controller 17 may retrieve content after a retrieval operation is input from the input unit 13 and the receiver 15 receives the input of the retrieval operation, or the retrieval controller 17 may retrieve content when the input of the symbol data is completed (when pen-up is detected in inputting the symbol data, for example). Examples of the retrieval operation include pressing of a retrieval button and input of predetermined writing.

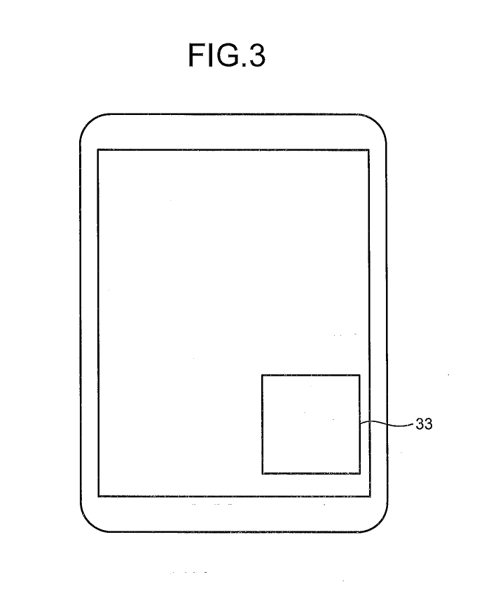

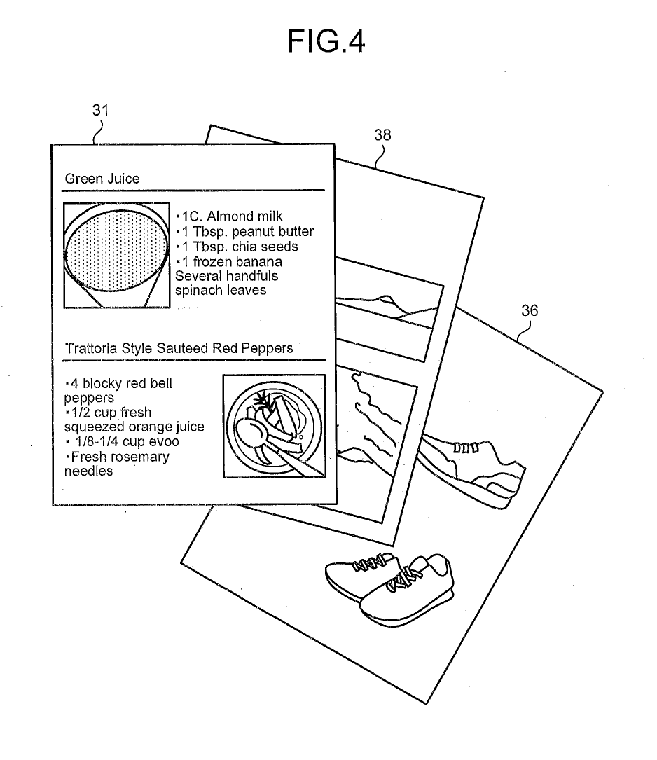

The following describes a retrieval example of the present embodiment with reference to FIG. 2 through FIG. 4. FIG. 2 is a diagram illustrating an example of content 31 to be retrieved in the present embodiment, FIG. 3 is a diagram illustrating an example of handwritten symbol data in the present embodiment, and FIG. 4 is a diagram illustrating an example of retrieval results in the present embodiment.

As illustrated in FIG. 2, it is assumed that there is an image (photograph) area 32 at the lower right part of the content 31 to be retrieved. In this case, as illustrated in FIG. 3, the input unit 13 inputs symbol data the type of which is the image and which designates an area 33 positioned at the lower right part of the page (for example, it is assumed that an image designation mode is selected from a menu of an application to designate the type labeled as image). The symbol data may be data that is set by recognizing the range or form of a lower right closed loop from handwritten data handwritten by the user.

The retrieval controller 17 then performs a retrieval using the input symbol data as a query and retrieves, from the storage 11, the record containing the second element information similar to the first element information, thereby retrieving content in which an image area is positioned at the lower right part of the page. Consequently, the retrieval result contains the content 31, content 36, and content 38 as illustrated in FIG. 4, whereby the content 31 to be retrieved is found.

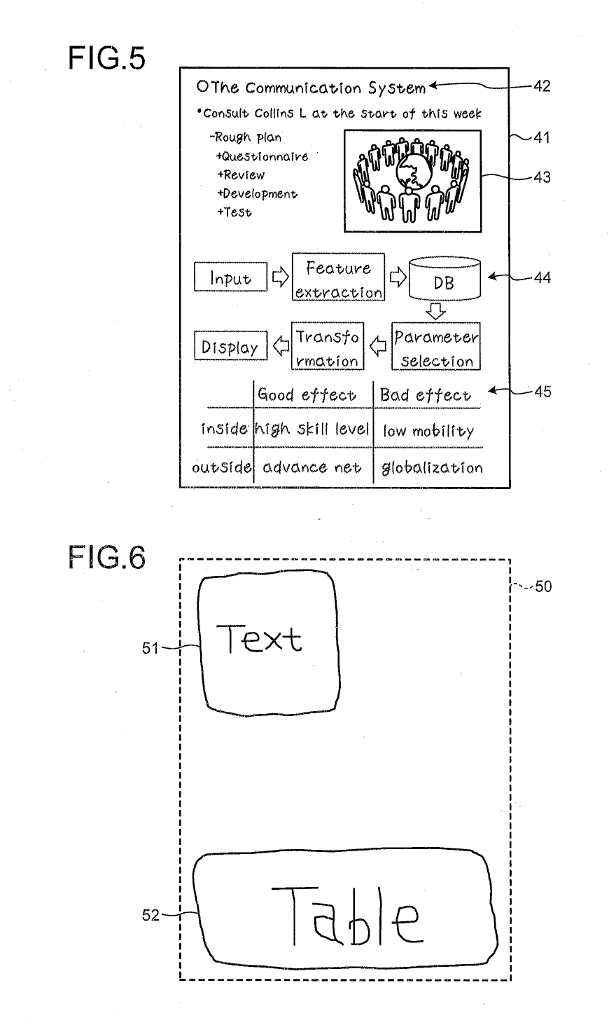

The following describes a specific example of a case of inputting the symbol data in the present embodiment by handwriting with reference to FIG. 5 through FIG. 10. FIG. 5 is a diagram illustrating an example of content 41 to be retrieved in the present embodiment. FIG. 6 through FIG. 10 are diagrams illustrating examples of the handwritten symbol data in the present embodiment.

As illustrated in FIG. 5, it is assumed that there are a text area 42 at the upper left part of the content 41 to be retrieved, an image (picture) area 43 at the upper right part of the content 41 to be retrieved, a figure area 44 at the middle part of the content 41 to be retrieved, and a table area 45 at the lower part of the content 41 to be retrieved.

In this case, for example, the pieces of handwritten symbol data illustrated in FIG. 6 through FIG. 10 can be considered as the handwritten symbol data for retrieving the content 41 to be retrieved.

The handwritten symbol data illustrated in FIG. 6 designates respective positions and a relative relation of the one or more second components of the content to be retrieved and respective types of the one or more second components with a handwritten circle or a handwritten polygon drawn at the respective positions of the one or more first components and handwritten text written in the handwritten circle or the handwritten polygon.

Specifically, according to the handwritten symbol data illustrated in FIG. 6, handwriting a polygon 51 containing text at the upper left part of a page 50 designates that there is a text area at the upper left part, and handwriting a polygon 52 containing a table at the lower part of the page 50 designates that there is a table area at the lower part. Various patterns may be prepared such as “Text,” “Character,” “Character String,” or “Sentence” for representing text and “Table,” “Chart,” or “Matrix” for representing a table.

Although in the example illustrated in FIG. 6 the handwritten text is written at each of the one or more first components, an icon or a stamp indicating the type of the first components may be used in place thereof. Colors may be designated. Respective areas of the symbol data may be written with a pen representing the color of an object to be retrieved. Text describing colors such as “Blue” and “Red” may be written within the range.

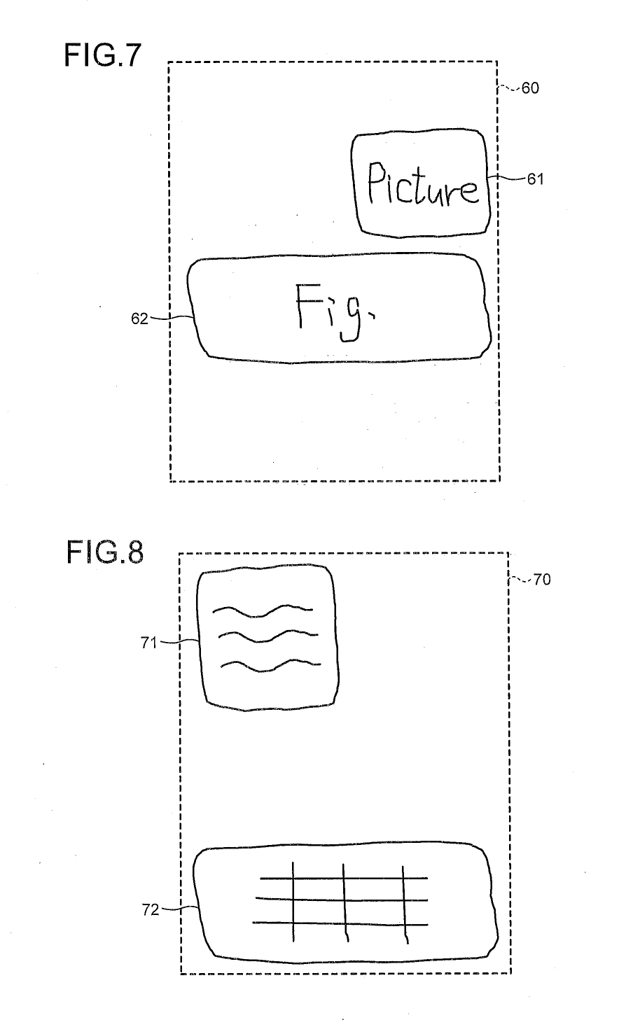

The handwritten symbol data illustrated in FIG. 7 performs designation different from FIG. 6. Handwriting a polygon 61 containing a photograph at the upper right part of a page 60 designates that there is a photograph area at the upper right part, and handwriting a polygon 62 containing a figure at the middle part of the page 60 designates that there is a figure area at the middle part.

The handwritten symbol data illustrated in FIG. 8 designates respective positions and a relative relation of the one or more first components and respective forms of the one or more first components with a handwritten circle or a handwritten polygon drawn at the respective positions of the one or more first components and a handwritten symbol (figure) drawn in the handwritten circle or the handwritten polygon.

Specifically, according to designation data illustrated in FIG. 8, handwriting horizontal lines (wavy lines or straight lines) as a symbol that conceptualizes text and a range 71 at the upper left part of a page 70 designates that there is a text area at the upper left part, and handwriting a grid as a symbol that conceptualizes a table and a range 72 at the lower part of the page 70 designates that there is a table area at the lower part. The number of the horizontal lines within the range 71 may correspond to the number of lines of the text area or may not correspond thereto.

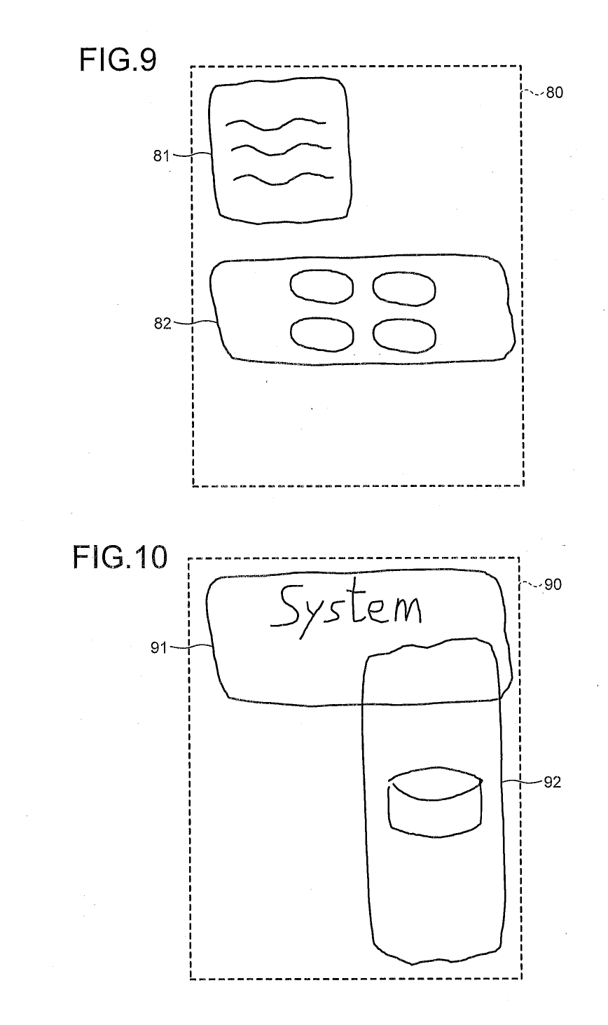

The handwritten symbol data illustrated in FIG. 9 performs designation different from FIG. 8. According to designation data illustrated in FIG. 9, handwriting horizontal lines (wavy lines or straight lines) as a symbol that conceptualizes text and a range 81 at the upper left part of a page 80 designates that there is a text area at the upper left part, and handwriting ellipses as a symbol that conceptualizes a figure and a range 82 at the middle part of the page 80 designates that there is a figure area at the middle part.

Although, in the examples illustrated in FIG. 8 and FIG. 9, the symbol that conceptualizes the text is the horizontal line, the symbol that conceptualizes the figure is the ellipse, and the symbol that conceptualizes the table is the grid, conceptualized symbols may be added or changed by additional learning or other methods.

The handwritten symbol data illustrated in FIG. 10 designates ranges containing the respective positions of the one or more first components and a relative relation between the ranges with a handwritten circle or a handwritten polygon drawn at the respective positions of the one or more first components and designates at least one of text to be retrieved and a figure to be retrieved with at least one of a handwritten text and a handwritten figure written or drawn in the handwritten circle or the handwritten polygon.

In this case, the retrieval controller 17 retrieves, as content to be retrieved, content in which the first element information and the second element information are similar to each other and in which at least one of the handwritten text or the handwritten figure is present at a position designated with the handwritten circle or the handwritten polygon in which at least one of the handwritten text and the handwritten figure is written or drawn among one or more pieces of content stored in the storage 11.

Specifically, according to the handwritten symbol data illustrated in FIG. 10, handwriting a polygon 91 at the upper part of a page 90 and handwriting “System” therein designates that there is a keyword “System” anywhere at the upper part, and handwriting a polygon 92 at the right part of the page 90 and handwriting a cylinder therein designates that there is a cylinder at the right area.

In the examples illustrated in FIG. 6 through FIG. 10, the handwritten symbol data can interactively be input, and the items described in FIG. 6 through FIG. 10 are not required to be input at a time and may be input stepwise while seeing a retrieval result. For example, after forming the handwritten symbol data as in FIG. 10, the polygon 92 may be moved or changed in size by touch and drag or other operations, and display of a list of retrieval results may be updated in accordance therewith.

The generating controller 19 generates a symbol image that symbolizes the one or more second components based on the second element information of the one or more second components of the content retrieved by the retrieval controller 17.

The symbol image is an image the type of which is symbolized by a name (a keyword) of the type, an icon, an illustration, or other items for each of the one or more second components. When the second element information indicates the position of the second component, the position of the symbol is determined to be a position corresponding to the position of the second component and, when the second element information indicates the size of the second component, the size of the symbol is determined to be a size corresponding to the size of the second component. When the second element information indicates the shape of the second component, the perimeter of the symbol is surrounded with a line along the shape of the second component and, when the second element information indicates the color of the second component, the color of the symbol is determined to be a color corresponding to the color of the second component.

The display controller 21 displays the symbol image generated by the generating controller 19 on the display 23.

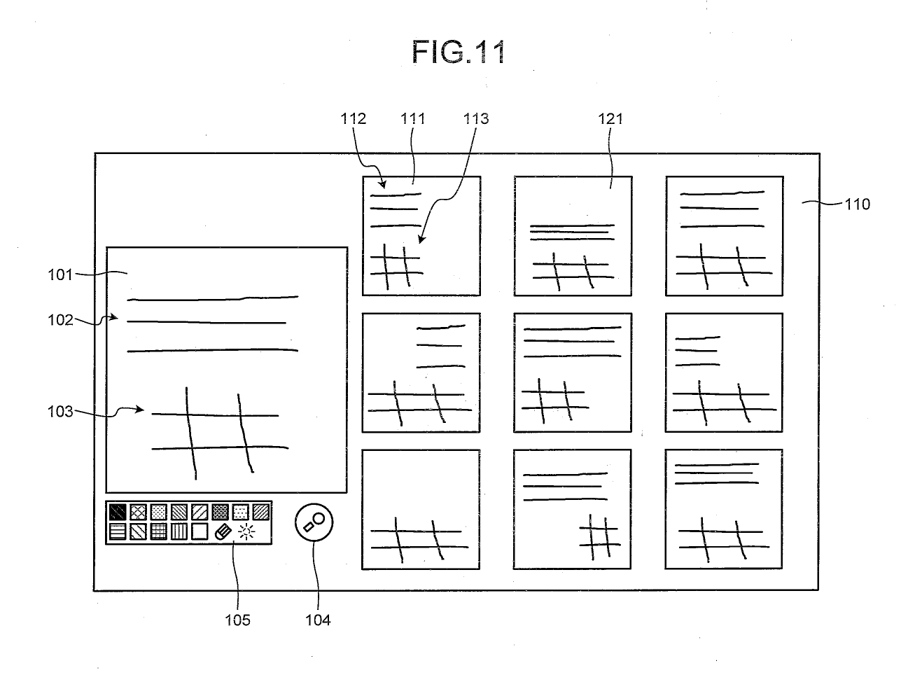

FIG. 11 is a diagram illustrating an example of a display screen of the present embodiment. In the example illustrated in FIG. 11, symbol data including symbols 102 and 103 of the first components is input to a retrieval window 101, and a retrieval button 104 is pressed down, whereby symbol images 111, 121, and other images in the pieces of the content retrieved are displayed on a retrieval result display area 110. An icon 105 enables the designation of the colors of the symbols 102 and 103 and other operations. The symbol image 111 includes symbols 112 and 113 of the second components.

In the example illustrated in FIG. 11, symbols constituting the symbol image are modified (moved, enlarged or contracted, changed in color, or removed, for example) for the symbols constituting the symbol images, and a display manner is achieved by which the user who has input the symbol data can understand the correspondence between the symbol data and the symbol images more easily.

In this case, the generating controller 19 may generate the symbol images based on the symbol data received by the receiver 15 and the second element information retrieved by the retrieval controller 17. In other words, when symbolizing the second component, the generating controller 19 modifies the symbol of the first component similar to the second component contained in the symbol data to generate the symbol of the second component.

The arrangement of the symbol images displayed on the retrieval result display area 110 may be in order of decreasing similarity between the symbol data and pieces of content as generation sources of the symbol images; for example, a symbol image having the highest similarity may be arranged at the upper left part and the others may be arranged so as to follow from the upper row to the lower row in order.

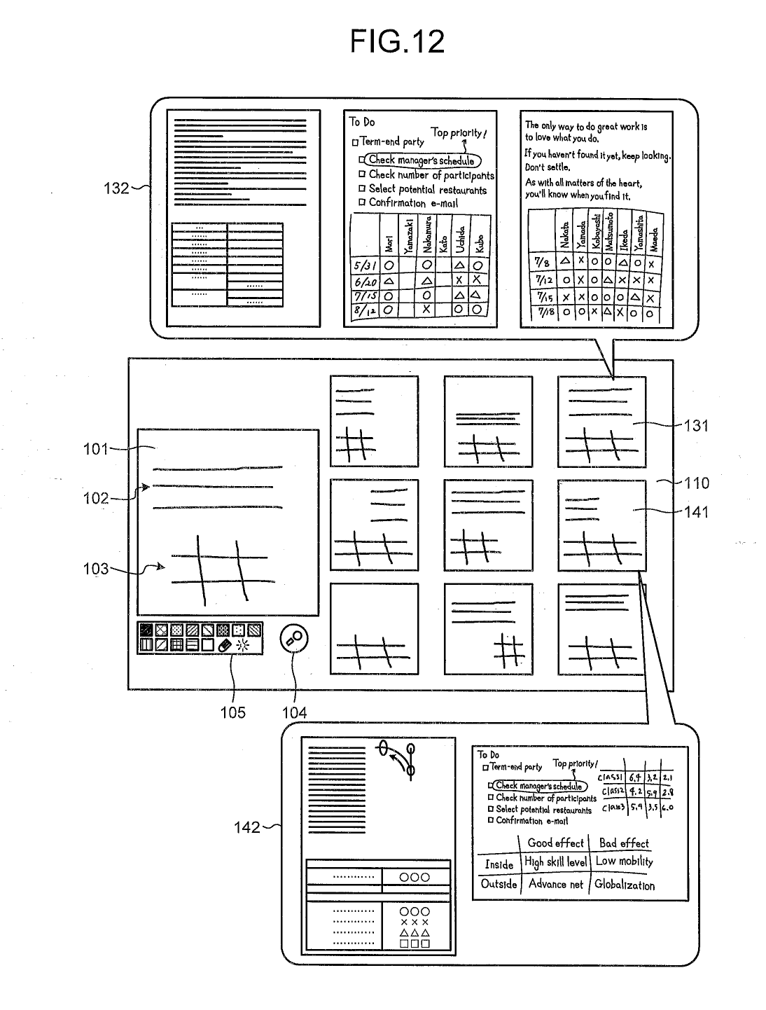

FIG. 12 is a diagram illustrating another example of the display screen of the present embodiment. In the example illustrated in FIG. 12, on the retrieval result display area 110, symbol images 131, 141, and other images in the pieces of the content retrieved are displayed, pieces of content 132 of the symbol image 131 are displayed in association with the symbol image 131, and pieces of content 142 of the symbol image 141 are displayed in association with the symbol image 141.

Instead of displaying the symbol images and the pieces of content in association with each other at all times, the display controller 21 may acquire content contained in a record containing the symbol image and display the content in association with the symbol image when an operation to designate (a touching operation or a cursor overlaying operation, for example) or select (a cursor overlaying and clicking operation, for example) the symbol image is input from the input unit 13 and is received by the receiver 15.

The display controller 21 may display pieces of content on the retrieval result display area 110, and when an operation to designate or select a piece of content is input from the input unit 13 and is received by the receiver 15, the display controller 21 may display the symbol image of the content in association therewith.

Instead of associating the symbol image and the content with each other, the display controller 21 may display the second component of the content corresponding to the symbol of the symbol image in association therewith.

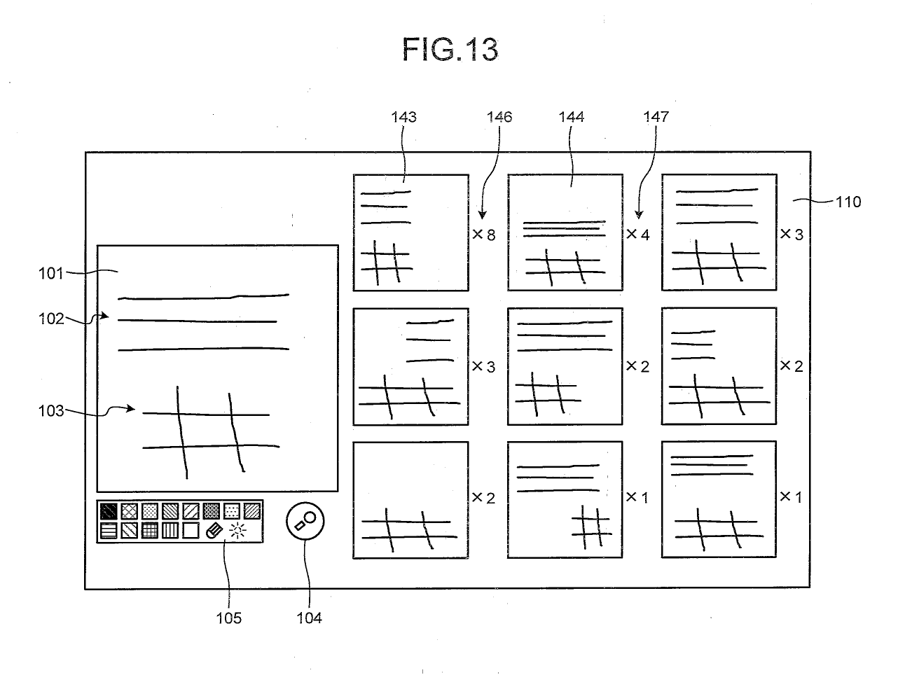

FIG. 13 is another example of the display screen of the present embodiment. In the example illustrated in FIG. 13, on the retrieval result display area 110, representative symbol images 143, 144, and other images generated based on the symbol data or a plurality of pieces of second element information are displayed, and number information 146 and 147 are displayed in association with the representative images 143 and 144, respectively.

When n records have been retrieved by the retrieval controller 17, for example, the generating controller 19 may further generate m (2≦m≦n) representative symbol images based on the symbol data received by the receiver 15 or n pieces of second element information contained in the n records, and the display controller 21 may display the m representative symbol images.

When generating the representative symbol images from the symbol data, the generating controller 19 may generate the m representative symbol images after changing at least one of a type, a position, a size, a shape, and a color of the symbols of the symbol data.

When generating the m representative symbol images from the n pieces of second element information, the generating controller 19 may classify the n pieces of second element information into m groups based on similarity or other characteristics, and generate a representative symbol image by averaging pieces of second element information classified into each group, and generate m representative symbol images.

The display controller 21 may classify the n pieces of second element information into the m representative symbol images and display number information indicating the number of the pieces of second element information classified into the m respective representative symbol images together with the m representative symbol images. When the classification of the n pieces of second element information has been performed by the generating controller 19, the display controller 21 may omit the classification.

The generating controller 19 may generate the m representative symbol images so that a difference between a maximum value and a minimum value of the number of the pieces of second element information classified into the m respective representative symbol images is a threshold or less. When the difference between the maximum value and the minimum values exceeds the threshold, the generating controller 19 may change a process for generating the m representative symbol images and regenerate the m representative symbol images. Examples of the process for generation include a change of an algorithm for calculating similarity and a change of weight for calculating similarity.

The arrangement of the representative symbol images on the retrieval result display area 110 may be in order of decreasing number of classified pieces of second element information; for example, a representative symbol image having the largest number may be arranged at the upper left part and the others may be arranged so as to follow from the upper row to the lower row in order.

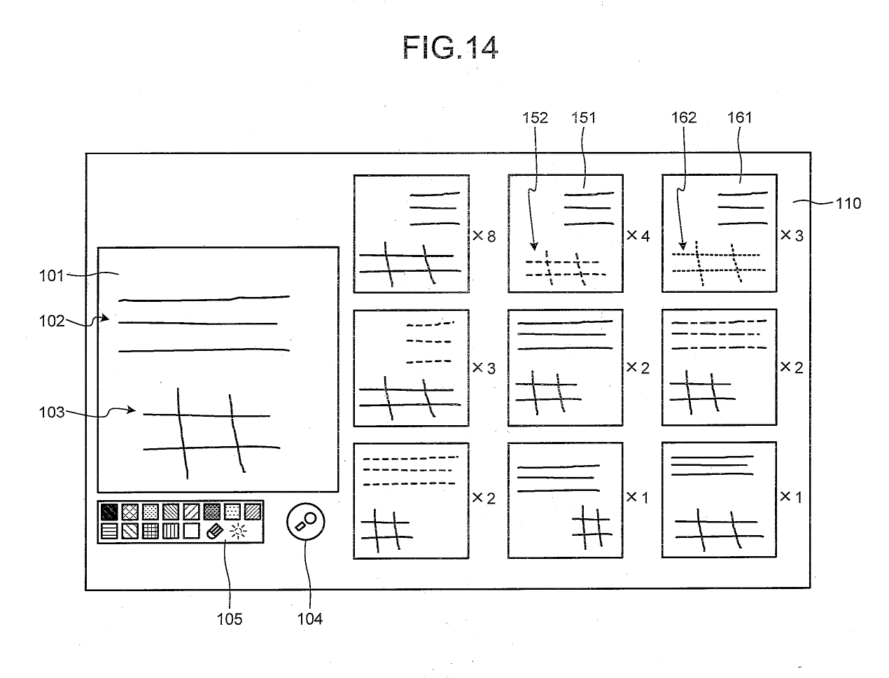

FIG. 14 is a diagram illustrating another example of the display screen of the present embodiment. In the example illustrated in FIG. 14, the color of the second element information is reflected in a symbol 152 of a representative symbol image 151 and a symbol 162 of a representative symbol image 161.

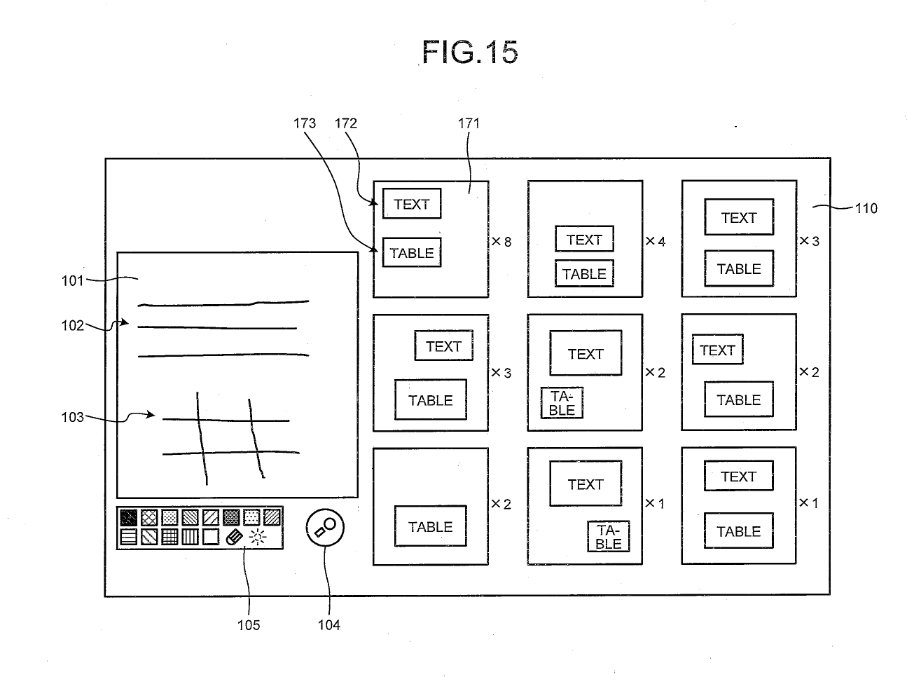

FIG. 15 is a diagram illustrating another example of the display screen of the present embodiment. In the example illustrated in FIG. 15, the generating controller 19, for each of the one or more second components, puts the type of the second component into words to generate symbol images. Although the symbols 102 and 103 of the first components correspond to symbol 172 and 173 of a symbol image 171, respectively, both symbols are different from each other. The example illustrated in FIG. 15 gives a display manner by which even a third party other than the user who has input the symbol data can easily understand the correspondence between the symbol data and the symbol images.

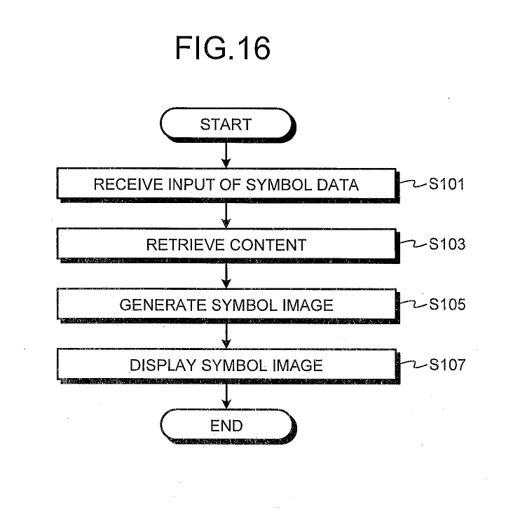

FIG. 16 is a flowchart illustrating an example of a procedure of the processing performed by the retrieval apparatus 10 of the present embodiment.

First, the receiver 15 receives input of the symbol data that designates the first element information that is at least one of the type, the position, the size, the shape, and the color of the one or more first components and symbolizes the one or more first components from the input unit 13 (Step S101).

The retrieval controller 17 then retrieves, from the storage 11, the record containing the second element information similar to the first element information and the content associated with the second element information based on the symbol data received by the receiver 15 (Step S103).

The generating controller 19 then generates the symbol image that symbolizes the one more second components based on the second element information associated with the content retrieved by the retrieval controller 17 (Step S105).

The display controller 21 then displays the symbol image generated by the generating controller 19 on the display 23 (Step S107).

As described above, the retrieval apparatus according to the present embodiment receives the designation of the first element information that is at least one of the type, the position, the size, the shape, and the color of the one or more first components, and receives input of symbol data that symbolizes the one or more first components; retrieves content based on the symbol data; and generates, based on the second element information that is at least one of the type, the position, the size, the shape, and the color of the one or more second components in the content retrieved, the symbol image that symbolizes the one or more second components; and displays the symbol image on the display. Therefore, the user is enabled to easily understand the correspondence between the one or more first components that have been used for retrieval and the one or more second components.

First Modification

Although, in the above embodiment, an example has been described in which the retrieval apparatus 10 includes the storage 11, the storage 11 may be provided outside (on a cloud, for example) the retrieval apparatus 10. Any component other than the storage 11 included in the retrieval 10 may be formed into a cloud. The retrieval apparatus 10 may be implemented by a plurality of distributed apparatuses.

Second Modification

In the above embodiment, the method for generating (the method for displaying) the symbol images may be switched through user operation input from the input unit 13. For example, the display manner as illustrated in FIG. 11 and the display manner as illustrated in FIG. 15 may be switched therebetween.

Third Modification

In the above embodiment, the content to be retrieved may be an electronic medical record.

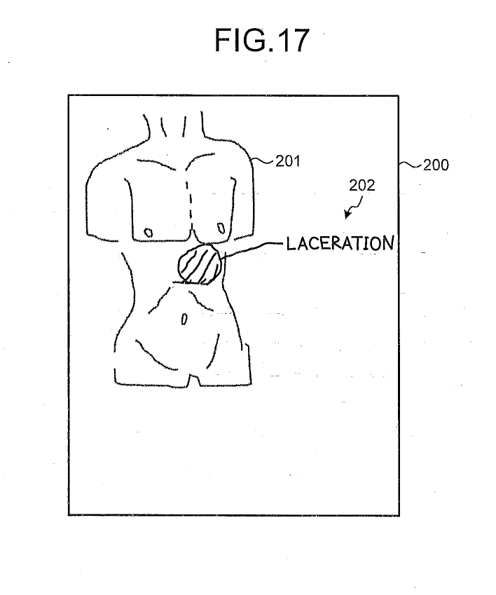

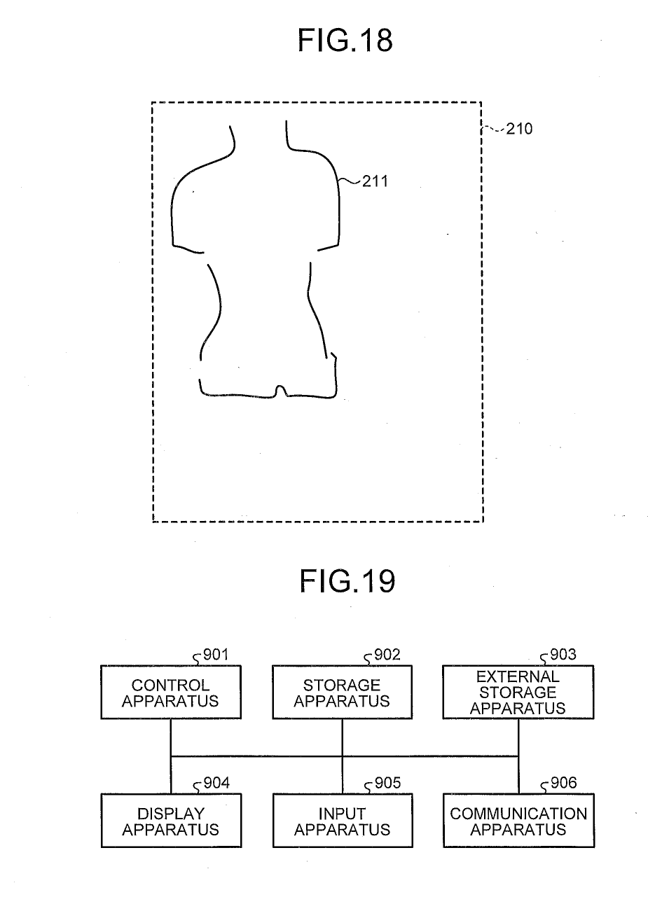

FIG. 17 is a diagram illustrating an example of content 200 to be retrieved in a third modification and FIG. 18 is a diagram illustrating an example of symbol data in the third modification.

As illustrated in FIG. 17, it is assumed that there is a schema area 201 at the upper left part of the content 200 to be retrieved, and there is a picture area indicating the site of an affected part and a text area 202 of a comment on the affected part at the central part of the schema. The schema is a template of a human body diagram, in which sites of affected parts, comments on the affected parts, and other items are written.

In this case, the symbol data illustrated in FIG. 18 is, for example, considered as symbol data for retrieving the content 200 to be retrieved.

The symbol data illustrated in FIG. 18 designates the position of the second component of the content to be retrieved and the type of the second component with a hand drawing (a rough sketch) drawn at the position of the first component.

Specifically, according to the symbol data illustrated in FIG. 18, handwriting a rough sketch 211 of the schema at the upper left part of a page 210 designates that there is a schema area at the upper left part.

In the third modification, the second element information further includes schema information. The schema information includes the position of the schema area and the type of the template of the schema.

The retrieval controller 17 may further retrieve a schema that matches the shape of the rough sketch of the symbol data. In this case, the retrieval controller 17 may use a technique called chamfer matching as a method for matching line drawings that generates images in which each pixel value depends on a distance from a line of the line drawing and the pixel value closer to the line of the line drawing has a larger value to determine the distance between the line drawings using a Euclidean distance between the images. The retrieval controller 17 may retrieve a template of the schema to which a written drawing is closest using the determined distance.

The generating controller 19 may generate a symbol image of the content retrieved, and the display controller 21 may display the generated symbol image.

Hardware Configuration

FIG. 19 is a diagram illustrating a hardware configuration example of the above retrieval apparatus of the embodiment and the modifications. The retrieval apparatus 10 of the above embodiment and modifications includes a controlling apparatus 901 such as a CPU, a storage apparatus 902 such as a ROM and a RAM, an external storage apparatus 903 such as a HDD, a display apparatus 904 such as a display, an input apparatus 905 such as a keyboard and a mouse, and a communication apparatus 906 such as a communication interface, which is a hardware configuration using a typical computer.

A computer program executed by the retrieval apparatus 10 of the above embodiment and modifications is recorded and provided in a computer-readable recording medium such as a CD-ROM, a CD-R, a memory card, a digital versatile disc (DVD), and a flexible disk (FD) as an installable or executable file.

The computer program executed by the retrieval apparatus 10 of the above embodiment and modifications may be stored in a computer connected to a network such as the Internet and provided by being downloaded via the network. Furthermore, the computer program executed by the retrieval apparatus 10 of the above embodiment and modifications may be provided or distributed via a network such as the Internet. The computer program executed by the retrieval apparatus 10 of the above embodiment and modifications may be stored in a ROM to be provided, for example.

The computer program executed by the retrieval apparatus 10 of the above embodiment and modifications is modularized to implement the above units on a computer. As actual hardware, the CPU reads the computer program from the HDD, loads the computer program thus read to the RAM, and executes the computer program, thereby implementing the above units on the computer.

For example, the steps in the flowchart of the above embodiment may be executed in a changed order, simultaneously executed, or executed in a different order for each execution, unless contrary to the nature thereof.

As described above, according to the above embodiment and modifications, users are enabled to easily understand the correspondence between information used for retrieval and retrieval results.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A retrieval apparatus comprising:
a receiver configured to receive designation of first element information that is at least one of a type, a position, a size, a shape, and a color of one or more first components, and to receive symbol data that symbolizes the one or more first components;
a retrieval controller configured to retrieve content based on the symbol data;
a generating controller configured to generate a symbol image that symbolizes the one or more second components in the content, based on second element information that is at least one of a type, a position, a size, a shape, and a color in the content; and
a display controller configured to display the symbol image on a display.

2. The apparatus according to claim 1, wherein the generating controller is configured to generate the symbol image based on the symbol data and the second element information.

3. The apparatus according to claim 1, wherein the generating controller is configured to generate, for each of the one or more second components, the symbol image by putting the type of the second component into words.

4. The apparatus according to claim 1, wherein the display controller is further configured to display the content in association with the symbol image on the display.

5. The apparatus according to claim 4, wherein when the symbol image displayed on the display is designated or selected, the display controller is further configured to display the content on the display.

6. The apparatus according to claim 1, wherein the display controller is configured to display, on the display, a second component as a generation source of a symbol constituting the symbol image in association with the symbol.

7. The apparatus according to claim 1, wherein, from storage that stores therein a plurality of records each of which associates content with the second element information of the content, the retrieval controller is configured to retrieve a record containing the second element information similar to the first element information.

8. The apparatus according to claim 7, wherein
when n (n≧2) records have been retrieved, the generating controller is configured to generate m (2≦m≦n) representative symbol images based on n pieces of second element information contained in the symbol data or the n records, and
the display controller is configured to display the m representative symbol images on the display.

9. The apparatus according to claim 8, wherein the display controller is configured to classify the n pieces of second element information into the m representative symbol images and to display number information indicating the number of the pieces of second element information classified into the m respective representative symbol images together with the m representative symbol images on the display.

10. The apparatus according to claim 9, wherein the generating controller is configured to generate the m representative symbol images so that a difference between a maximum value and a minimum value of the number of the pieces of second element information classified into the m representative symbol images is equal to a threshold or less.

11. The apparatus according to claim 10, wherein when the difference exceeds the threshold, the generating controller is configured to change a process for generating the m representative symbol images and regenerates the m representative symbol images.

12. A retrieval method comprising:
receiving designation of first element information comprising at least one of a type, a position, a size, a shape, and a color of one or more first components, and receiving symbol data that symbolizes the one or more first components;
retrieving content based on the symbol data;
generating a symbol image that symbolizes the one or more second components in the content, based on second element information that is at least one of a type, a position, a size, a shape, and a color in the content; and
displaying the symbol image on a display.

13. A computer program product comprising a non-transitory computer-readable medium including programmed instructions, the instructions causing a computer to execute a method comprising:
receiving designation of first element information comprising at least one of a type, a position, a size, a shape, and a color of one or more first components, and receiving symbol data that symbolizes the one or more first components;
retrieving content based on the symbol data;
generating a symbol image that symbolizes the one or more second components in the content, based on second element information that is at least one of a type, a position, a size, a shape, and a color in the content; and
displaying the symbol image on a display.
